(19) United States
(12) Patent Application Publication
(10) Pub. No.: US 2017/0080858 A1
(43) Pub. Date: Mar. 23, 2017

(54) Proximity Alert System

(71) Applicants: Gary Dotson, Crawley, WV (US); Darold Carter, Crawley, WV (US)

(72) Inventors: Gary Dotson, Crawley, WV (US); Darold Carter, Crawley, WV (US)

(21) Appl. No.: 14/859,451

(22) Filed: Sep. 21, 2015

(51) Int. Cl. B60Q 9/00

(52) U.S. Cl. CPC B60Q 9/008

(57) ABSTRACT

A proximity alert system includes a truck. A sensing array is coupled to the truck and the sensing array detects an object behind the truck when the truck is driven rearwardly. The sensing array emits an audible alarm when the sensing array detects the object. The audible alarm communicates a distance between the truck and the object. Thus, the sensing array inhibits the truck from striking the object when the truck is driven rearwardly.

### BACKGROUND OF THE DISCLOSURE

### Field of the Disclosure

The disclosure relates to alert devices and more particularly pertains to a new alert device for inhibiting a truck from backing into an object.

### SUMMARY OF THE DISCLOSURE

An embodiment of the disclosure meets the needs presented above by generally comprising a truck. A sensing array is coupled to the truck and the sensing array detects an object behind the truck when the truck is driven rearwardly. The sensing array emits an audible alarm when the sensing array detects the object. The audible alarm communicates a distance between the truck and the object. Thus, the sensing array inhibits the truck from striking the object when the truck is driven rearwardly.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF THE DRAWINGS

The disclosure will be better understood and objects other than those set forth above will become apparent when consideration is given to the following detailed description thereof. Such description makes reference to the annexed drawings wherein:

FIG. 1 is a perspective view of a proximity alert system according to an embodiment of the disclosure.

FIG. 2 is a back view of an embodiment of the disclosure.

FIG. 3 is a perspective in-use view of an embodiment of the disclosure.

FIG. 4 is a back perspective view of an embodiment of the disclosure.

FIG. 5 is a schematic view of an embodiment of the disclosure.

### DESCRIPTION OF THE PREFERRED EMBODIMENT

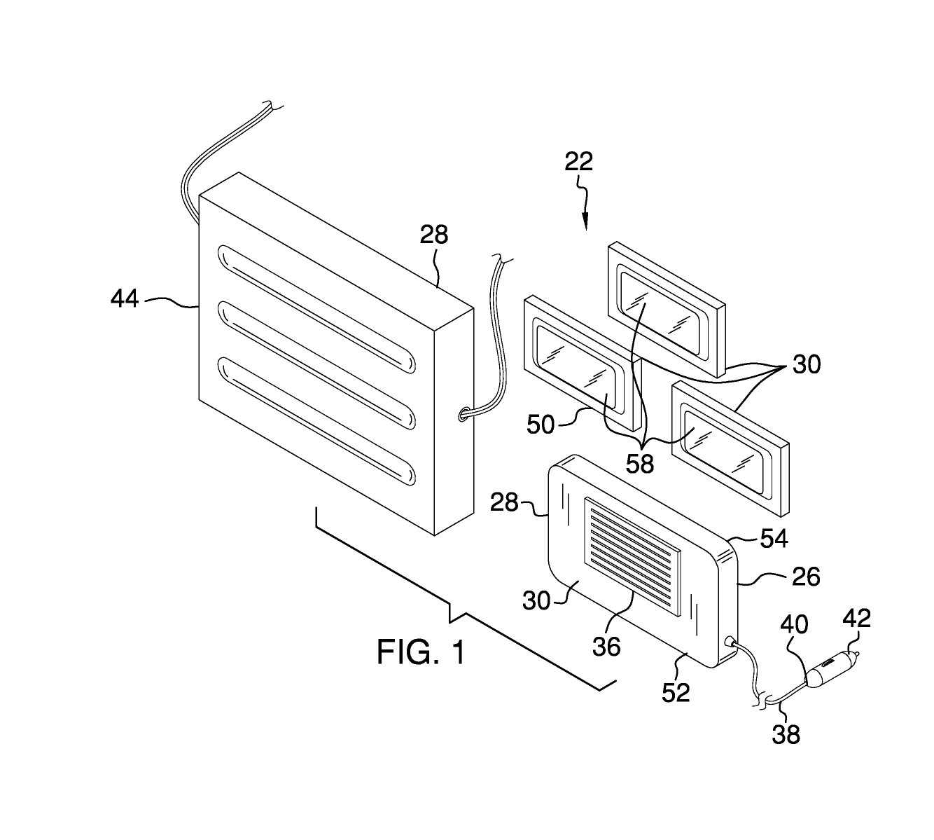

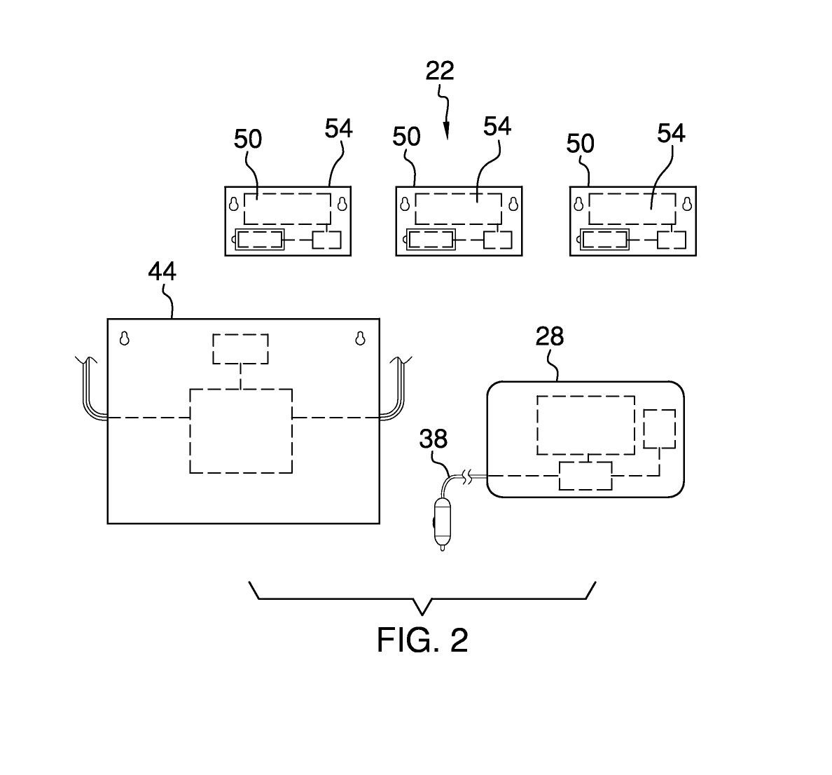

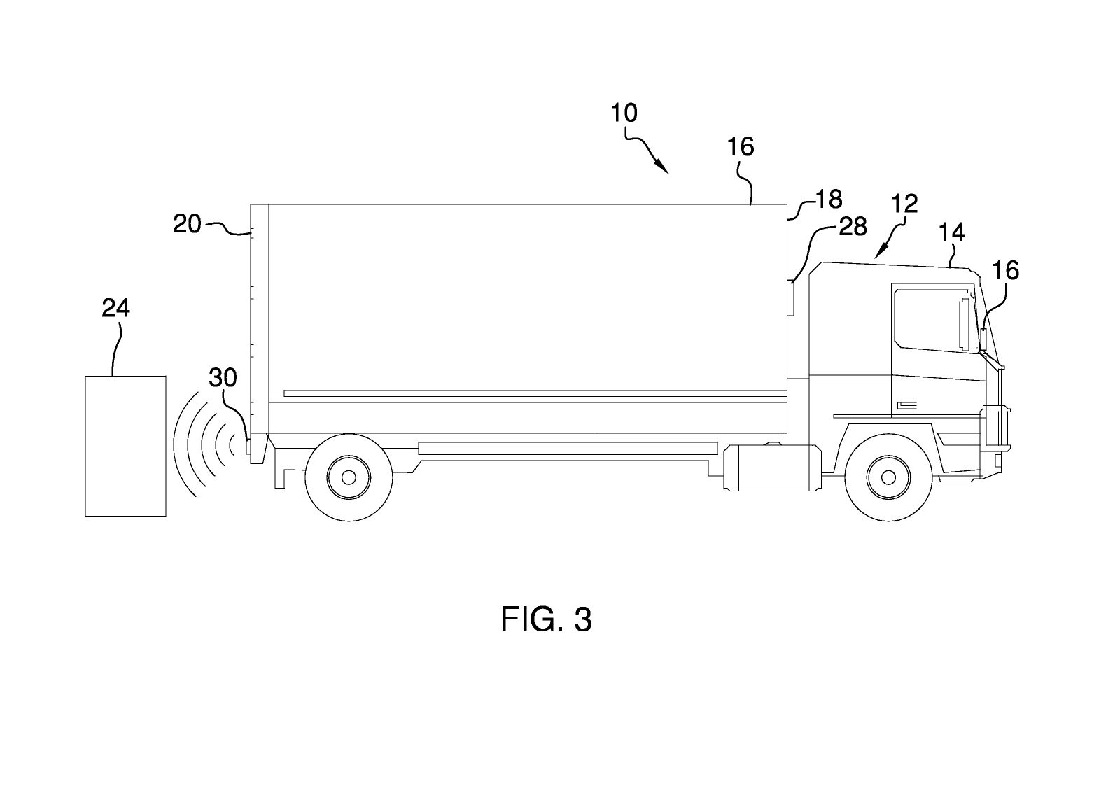

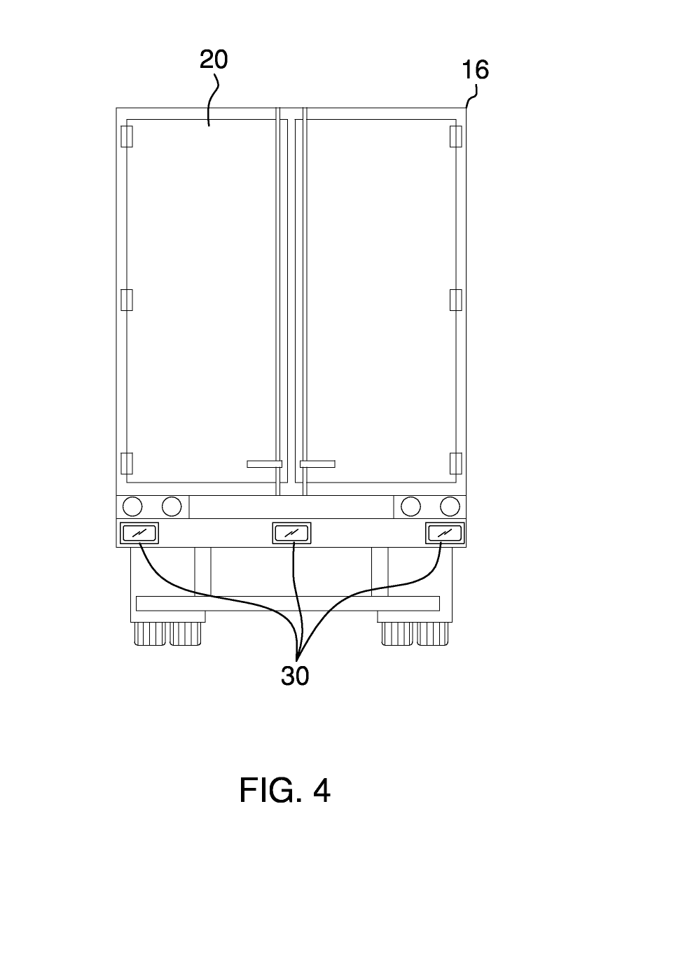

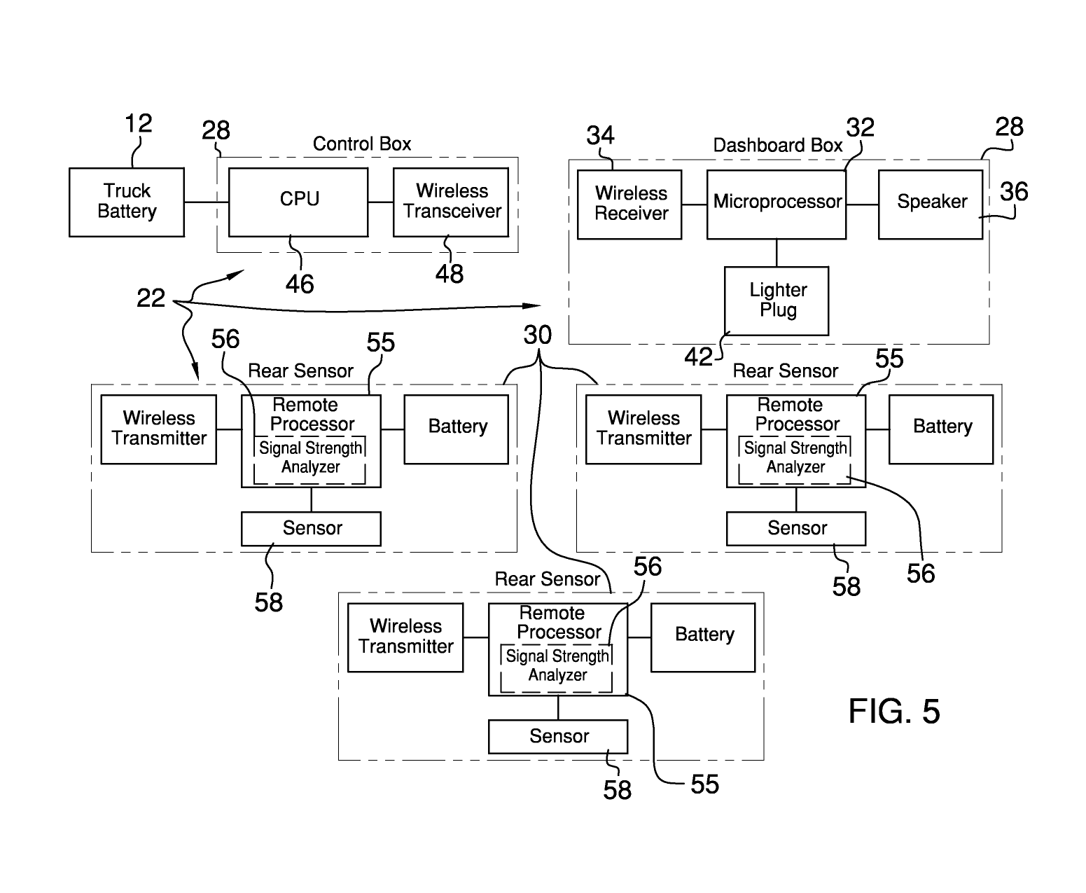

With reference now to the drawings, and in particular to FIGS. 1 through 5 thereof, a new alert device embodying the principles and concepts of an embodiment of the disclosure and generally designated by the reference numeral 10 will be described.

As best illustrated in FIGS. 1 through 5, the proximity alert system 10 generally comprises a truck 12 that has a cab section 14 and a box section 16. The box section 16 has a front side 18 and a rear side 20. The truck 12 may comprise a tractor trailer, a box truck or a bus. Additionally, the truck 12 may have a length that is greater than six meters.

A sensing array 22 is coupled to the truck 12. The sensing array 22 detects an object 24 behind the truck 12 when the truck 12 is being driven rearwardly. The sensing array 22 emits an audible alarm when the sensing array 22 detects the object 24. The audible alarm communicates a distance between the truck 12 and the object 24. Thus, the sensing array 22 inhibits the truck 12 from striking the object 24 when the truck 12 is being driven rearwardly.

The sensing array 22 comprises a base unit 26, a control unit 28 and a plurality of remote units 30. The base unit 26 is positioned within the cab section 14 and the base unit 26 comprises a base housing 28 that has a front wall 30. A base processor 32 is positioned within the base housing 28 and the base processor 32 may comprise an electronic processor or the like.

A receiver 34 is positioned within the base housing 28 and the receiver 34 is electrically coupled to the base processor 32. The receiver 34 may comprise a radio frequency receiver or the like. A speaker 36 is coupled to the front wall 30 and the speaker 36 is electrically coupled to the base processor 32.

A base power cord 38 extends outwardly from the base housing 28 and the base power cord 38 is electrically coupled to the base processor 32. The base power cord 38 has a distal end 40 with respect to the base housing 28. The distal end 40 has a plug 42 electrically coupled thereto and the plug 42 is selectively electrically coupled to the truck 12. The plug 42 may comprise a cigarette lighter adapter or the like.

The control unit 28 is coupled to the box section 16 and the control unit 28 is positioned on the front side 18 of the box section 16. The control unit 28 comprises a control housing 44 that is coupled to the front side 18 of the box section 16. A control processor 46 is positioned within the control housing 44 and the control processor 46 is electrically coupled to the truck 12. Thus, the control processor 46 determines when the truck 12 is being driven rearwardly. A transceiver 48 is positioned within the control housing 44 and the transceiver 48 is electrically coupled to the control processor 46. The transceiver 48 is in electrical communication with the receiver 34 and the transceiver 48 may comprise a radio frequency transceiver.

Each of the remote units 30 is coupled to the box section 16. Each of the remote units 30 is positioned on the rear side 20 of the box section 16 such that each of the remote units 30 may detect the object 24. The remote units 30 are spaced apart from each other and are distributed along the rear side 20. Each of the remote units 30 generates an alarm sequence when the remote units 30 detect the object 24 and each of the remote units 30 is in electrical communication with the control unit 28. The control unit 28 communicates the alarm sequence to the base unit 26 such that the base unit 26 emits the audible alarm thereby facilitating the truck 12 to avoid striking the object 24.

Each of the remote units 30 comprises a remote housing 50 that has a front wall 52 and a back wall 54. The back wall 54 is coupled to the rear side 20 of the box section 16. A remote processor 55 is positioned within the remote housing 50 and the remote processor 55 selectively generates the alarm sequence. The remote processor 55 may comprise an electronic processor or the like and the remote processor 55 includes a signal strength analyzer 56.

A sensor 58 is coupled to the front wall 52 of the remote housing 50 and the sensor 58 detects the object 24 when the truck 12 is driven rearwardly. The sensor 58 is electrically coupled to the remote processor 55 such that the remote processor 55 determines a distance between the sensor 58 and the object 24. The sensor 58 may comprise an electromagnetic proximity sensor or an ultrasonic proximity sensor. The remote processor 55 generates the alarm sequence when a distance between the truck 12 and the object 24 reaches a trigger distance. The trigger distance may be a distance ranging between approximately three meters and four meters.

The audible alarm may comprise a sequence of beeps. A duration of time between the sequence of beeps may decrease as the distance between the object 24 and the truck 12 decreases. Thus, the sequence of beeps communicates a distance between the truck 12 and the object 24. The audible alarm may comprise a voice. The voice may speak words relating to the object 24 and the distance between the truck 12 and the object 24.

A transmitter 60 is positioned within the remote housing 50 and the transmitter 60 is electrically coupled to the remote processor 55. The transmitter 60 is in electrical communication with the transceiver 48. The transmitter 60 may comprise a radio frequency transmitter. The receiver 34, the transceiver 48 and the transmitter 60 may utilize a WPAN signal or the like.

A remote power supply 62 is positioned within the remote housing 50. The remote power supply 62 is electrically coupled to the remote processor 55. The remote power supply 62 comprises at least one battery 64. The base unit 26 and each of the remote units 30 may be synced with the control unit via Bluetooth technology or the like.

In use, the base unit 26 is positioned within the cab section 14 of the truck 12. The base unit 26 and each of the remote units 30 are synced with the control unit 28. The base unit 26 begins to emit the audible alarm when the remote units 30 detect the object 24 is within the trigger distance with respect to the box section 16 of the truck 12. The base unit 26 continuously emits the audible alarm until the truck 12 is no longer moving rearwardly and when the truck 12 begins to move forwardly. The base unit 26 decreases the likelihood that the truck 12 will strike the object 24 while the truck 12 is being driven rearwardly.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A proximity alert system comprising:
a truck; and
a sensing array being coupled to said truck wherein said sensing array is configured to detect an object behind said truck when said truck is being driven rearwardly, said sensing array emitting an audible alarm when said sensing array detects the object, said audible alarm communicating a distance between said truck and the object wherein said sensing array is configured to inhibit said truck from striking the object when said truck is being driven rearwardly, said sensing array comprising a base unit, a control unit and a plurality of remote units.

2. The assembly according to claim 1, wherein:
said truck has a cab section; and
said base unit is positioned within said cab section, said base unit comprising:
a base housing having a front wall; and
a base processor being positioned within said base housing.

3. The assembly according to claim 2, further comprising:
a receiver being positioned within said base housing, said receiver being electrically coupled to said base processor; and
a speaker being coupled to said front wall, said speaker being electrically coupled to said base processor.

4. The assembly according to claim 2, further comprising a base power cord extending outwardly from said base housing, said base power cord being electrically coupled to said base processor, said base power cord having a distal end with respect to said base housing, said distal end having a plug being electrically coupled thereto, said plug being selectively electrically coupled to said truck.

5. The assembly according to claim 1, wherein:
said truck has a box section, said box section having a front side; and
said control unit is coupled to said box section, said control unit being positioned on said front side of said box section, said control unit being in electrical communication with said base unit.

6. The assembly according to claim 5, wherein said control unit comprises:
a control housing being coupled to said front side of said box section; and
a control processor being positioned within said control housing, said control processor being electrically coupled to said truck.

7. The assembly according to claim 6, further comprising:
a receiver; and
a transceiver being positioned within said control housing, said transceiver being electrically coupled to said control processor, said transceiver being in electrical communication with said receiver.

8. The assembly according to claim 1, wherein:
each of said remote units is coupled to said box section, each of said remote units being positioned on said back side of said box section wherein each of said remote units is configured to detect the object, said remote units being spaced apart from each other and distributed along said back side; and
each of said remote units generates an alarm sequence when said remote units detects the object, each of said remote units being in electrical communication with said control unit, said control unit communicating the alarm sequence to said base unit such that said base unit emits the audible alarm thereby facilitating said truck to avoid striking the object.

9. The assembly according to claim 8, wherein each of said remote units comprises:
a remote housing having a front wall and a back wall, said back wall being coupled to said back side of said box section; and
a remote processor being positioned within said remote housing, said remote processor selectively generating said alarm sequence.

10. The assembly according to claim 9, further comprising a sensor being coupled to said front wall wherein said sensor is configured to detect the object when said truck is driven rearwardly, said sensor being electrically coupled to said remote processor such that said remote processor determines a distance between said sensor and the object, said remote processor generating said alarm sequence when a distance between said truck and the object reaches a trigger distance.

11. The assembly according to claim 9, further comprising:
a transceiver; and
a transmitter being positioned within said remote housing, said transmitter being electrically coupled to said remote processor, said transmitter being in electrical communication with said transceiver.

12. The assembly according to claim 9, further comprising a remote power supply being positioned within said remote housing, said remote power supply being electrically coupled to said remote processor, said remote power supply comprising at least one battery.

13. A proximity alert system comprising:
a truck having a cab section and a box section, said box section having a front side and a rear side; and
a sensing array being coupled to said truck wherein said sensing array is configured to detect an object behind said truck when said truck is being driven rearwardly, said sensing array emitting an audible alarm when said sensing array detects the object, said audible alarm communicating a distance between said truck and the object wherein said sensing array is configured to inhibit said truck from striking the object when said truck is being driven rearwardly, said sensing array comprising:
a base unit being positioned within said cab section, said base unit comprising:
a base housing having a front wall,
a base processor being positioned within said base housing,
a receiver being positioned within said base housing, said receiver being electrically coupled to said base processor,
a speaker being coupled to said front wall, said speaker being electrically coupled to said base processor, and
a base power cord extending outwardly from said base housing, said base power cord being electrically coupled to said base processor, said base power cord having a distal end with respect to said base housing, said distal end having a plug being electrically coupled thereto, said plug being selectively electrically coupled to said truck;
a control unit being coupled to said box section, said control unit being positioned on said front side of said box section, said control unit being in electrical communication with said base unit, said control unit comprising:
a control housing being coupled to said front side of said box section,
a control processor being positioned within said control housing, said control processor being electrically coupled to said truck, and
a transceiver being positioned within said control housing, said transceiver being electrically coupled to said control processor, said transceiver being in electrical communication with said receiver; and
a plurality of remote units, each of said remote units being coupled to said box section, each of said remote units being positioned on said back side of said box section wherein each of said remote units is configured to detect the object, said remote units being spaced apart from each other and distributed along said back side, each of said remote units generating an alarm sequence when said remote units detects the object, each of said remote units being in electrical communication with said control unit, said control unit communicating the alarm sequence to said base unit such that said base unit emits the audible alarm thereby facilitating said truck to avoid striking the object, each of said remote units comprising:
a remote housing having a front wall and a back wall, said back wall being coupled to said back side of said box section,
a remote processor being positioned within said remote housing, said remote processor selectively generating said alarm sequence,
a sensor being coupled to said front wall wherein said sensor is configured to detect the object when said truck is driven rearwardly, said sensor being electrically coupled to said remote processor such that said remote processor determines a distance between said sensor and the object, said remote processor generating said alarm sequence when a distance between said truck and the object reaches a trigger distance,
a transmitter being positioned within said remote housing, said transmitter being electrically coupled to said remote processor, said transmitter being in electrical communication with said transceiver, and
a remote power supply being positioned within said remote housing, said remote power supply being electrically coupled to said remote processor, said remote power supply comprising at least one battery.
